(19) United States
(12) Patent Application Publication
(10) Pub. No.: US 2013/0219445 A1
(43) Pub. Date: Aug. 22, 2013

(54) APPARATUS AND METHOD FOR SELECTING MEDIA TRANSFER TERMINAL

(71) Applicants: Jae-Chan SHIM, Daejeon-si (KR); Hwa-Suk KIM, Daejeon-si (KR); Hwa-Shin MOON, Daejeon-si (KR); Dong-Hun LEE, Daejeon-si (KR); Kee-Seong CHO, Daejeon-si (KR)

(72) Inventors: Jae-Chan SHIM, Daejeon-si (KR); Hwa-Suk KIM, Daejeon-si (KR); Hwa-Shin MOON, Daejeon-si (KR); Dong-Hun LEE, Daejeon-si (KR); Kee-Seong CHO, Daejeon-si (KR)

(73) Assignee: Electronics and Telecommunications Research Institute, Daejeon (KR)

(21) Appl. No.: 13/547,789

(22) Filed: Jul. 12, 2012

(30) Foreign Application Priority Data
Feb. 22, 2012 (KR) 10-2012-0018138

(51) Int. Cl. H04N 7/173

(52) U.S. Cl. 725/114

(57) ABSTRACT

A method of selecting one or more media transfer terminals to which to transfer each of one or more media composing multimedia by a media transfer terminal determining server is provided. The method includes recognizing a change in a location of a user, recognizing available terminals at the changed location of the user, recognizing attribute information of a multimedia service being currently used by the user, and selecting one or more of the available terminals through which to provide one or more media according to the attribute information.

### CROSS-REFERENCE TO RELATED APPLICATION

This application claims the benefit under 35 U.S.C. §119(a) of a Korean Patent Application No. 10-2012-0018138, filed on Feb. 22, 2012, the entire disclosure of which is incorporated herein by reference for all purposes.

### BACKGROUND

1. Field

The following description relates to an apparatus and method for selecting a media transfer terminal, and more particularly, to an apparatus and method for supporting a user possessing a number of different kinds of wired and wireless terminals in an IP network environment to change a terminal without stopping a service in use.

2. Description of the Related Art

Session mobility to ensure service mobility means moving a current session to a changed network or terminal if there is a change in an accesses network or a terminal during a service session. When moving a session in this way, providing the session without disconnection or a corresponding service without interruption is called service continuity.

In 3GPP (3rd Generation Partnership Project), standardization with regard to ensuring continuity between access networks has been carried out to ensure service continuity, and standardization with regard to ensuring continuity according to service mobility between terminals is currently underway.

However, in a conventional inter-terminal service transfer method, a terminal to transfer to is selected on the assumption that all media composing a multimedia service in use is transferred. In other words, conventional technology does not consider separate transfer control of various media composing multimedia services.

However, a user may want a terminal transfer to be carried out per medium composing a multimedia service. For example, there may be a user who uses a VoD service on a smart phone while returning home from work. To continue watching the service in use after arriving home, the user may want to receive video through a TV operating as network terminal in his house and audio through a surround-sound speaker system operating as a network terminal not directly connected to the TV. In this case, the VoD service provided through the single smart phone has to be separated into its component media (video and audio) and provided through two terminals (the TV and the surround-sound speaker system). Alternatively, the user after arriving home may want to receive only video through the TV and continue listening to audio through his smart phone.

There is a need for control technology to separately transfer each medium between terminals so that different media composing the multimedia service provided through single terminal can be separately provided through several user terminals, as described above.

### SUMMARY

The following description relates to an apparatus and method for selecting a media transfer terminal that select and inform a user of a user terminal among a plurality of user terminals that is most suitable to transfer to for each medium composing a multimedia service in use.

Other features and aspects will be apparent from the following detailed description, the drawings, and the claims.

### BRIEF DESCRIPTION OF THE DRAWINGS

FIG. 1 is a diagram illustrating an example of a service network system to which the present invention is applied;

FIG. 2 is a diagram illustrating an example of a server for determining a media transfer terminal according to an example embodiment of the present invention; and

FIG. 3 is a flowchart illustrating an example of a method of determining a media transfer terminal according to an example embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

The present invention according to example embodiments is described in detail below with reference to the drawings.

The present invention provides an apparatus and method for determining one or more most suitable transfer terminals for each medium composing a multimedia service in use based on various information (for example, user subscription service information, user terminal information, etc.) and user preference information regarding media composing a service, and informing a user of the determination.

The example embodiments of the present invention are described in detail with reference to the drawings.

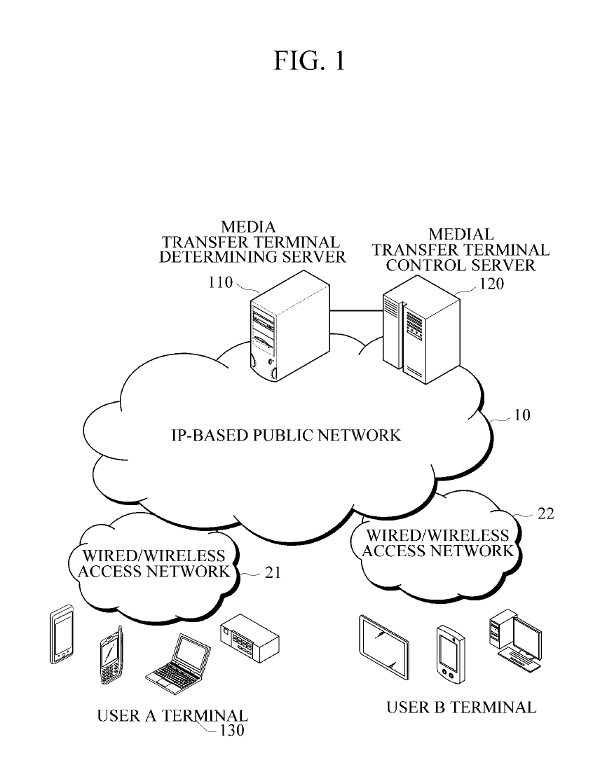

FIG. 1 is a diagram illustrating an example of a service network system to which the present invention is applied.

Referring to FIG. 1, the network system includes an IP-based public network 10, wired/wireless access networks 21 and 22 to access the public network for enabling a user to receive services, a server 110 for determining a media transfer terminal, a server 120 for controlling a media transfer terminal, and user terminals 130 possessed by users.

The IP-based public network 10 is a network supporting IP-based communication and includes a BcN (Broadband convergence Network). The BcN is an integrated network that safely provides an integrated broadband multimedia service such as the communication, broadcast, and Internet.

The wired/wireless access networks 21 and 22 are a wired network and a wireless network that support IP communication as well. Examples of the wireless network include a mobile communication network, such as LTE (Long Term Evolution) and CDMA (Code Division Multiple Access), a Wibro network, a Wireless network LAN, etc. Examples of the wired network include a PON (Passive Optical Network), an optical LAN, an xDSL (Digital Subscriber Line), etc.

The user terminals 130 are various types of terminals that can access the wired/wireless networks through IP communication, and include mobile phones, PDAs, PMPs, MIDs, smart phones, notebook computers, net books, PCs, and IP STBs (Set Top Boxes). In addition, the user terminals 130 include home theaters, beam projectors and other consumer electronics that can connect to networks.

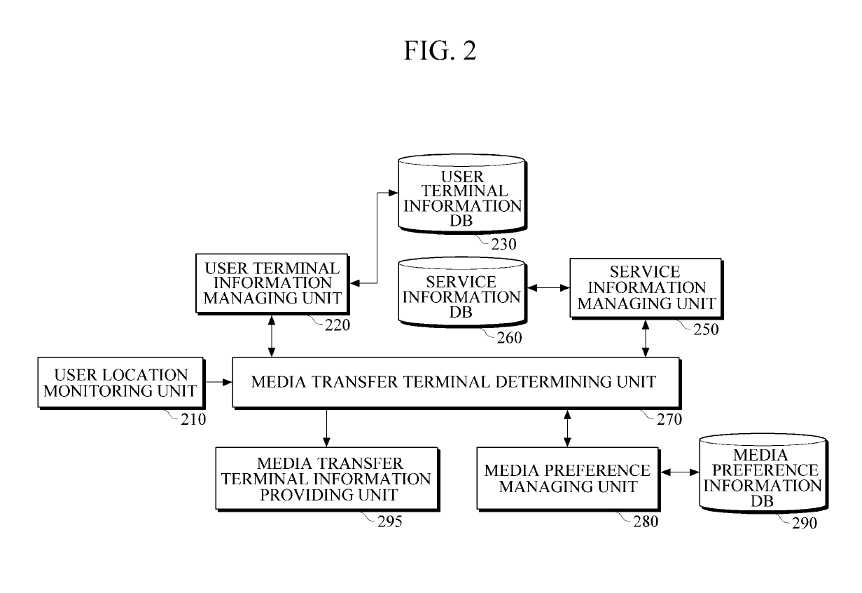

The media transfer terminal determining server 110 determines, depending on a changed location of a user, one or more most suitable terminals among the user terminals 130 existing at the changed location for each medium composing a multimedia service being currently provided to the user, and informs the user of the determination. This is described in detail below with reference to FIG. 2.

The media transfer terminal control server 120 enables one or more media composing multimedia to be separately provided to each of one or more transfer terminals informed from the media transfer terminal determining server 110.

FIG. 2 is a diagram illustrating an example of a server for determining a media transfer terminal according to an example embodiment of the present invention.

Referring to FIG. 2, the media transfer terminal determining server 110 includes a user location monitoring unit 210, a user terminal information managing unit 220, user terminal information DB 230, a service information managing unit 250, service information DB 260, a media transfer terminal determining unit 270, and a media transfer terminal information providing unit 295. According to the present invention, the media transfer terminal determining server further includes a media preference managing unit 280 and media preference information DB 290.

The user location monitoring unit 210 monitors the current location of a user and outputs a change in user location to the media transfer terminal determining unit 270. To do this, the user location monitoring unit 210 continues tracking the location of a terminal being currently used by a user using a location searching system such as GPS outdoors or RFID or wireless AP indoors. The media transfer terminal determining unit 270 initiates operations to determine one or more transfer terminals to which to transfer each medium composing multimedia as the location of the user changes.

The user terminal information managing unit 220 continues monitoring the attributes and state information of terminals possessed by each user, stores and manages the information monitored in the user terminal information DB 230.

The user terminal information DB 230 stores the kinds and state information of terminals possessed by each user in a tabular format, one example of which is Table 1 below.

TABLE 1

| | | Mobility | Available | Available | | Current | |
|---|---|---|---|---|---|---|---|
| User | Terminal | Support | Services | Media | Terminal Attributes | Location | Current State |
| John | PC | Supported | Broadcast, | Video, | CPU Performance, | Work | Available |
| | | | Messenger, | Audio, | Memory | | |
| | | | Voice Call, | Image, | Performance, | | |
| | | | Video Call, | Text, . . . | Audio Quality, | | |
| | | | Conference | | Video Quality, | | |
| | | | Call, | | Voice Codec, | | |
| | | | | | Video Codec, . . . | | |
| | Notebook | Not | Broadcast, | Video, | CPU Performance, | Work | Unavailable |
| | Computer | Supported | Messenger, | Audio, | Memory | | |
| | | | Voice Call, | Image, | Performance, | | |
| | | | Video Call, | Text, . . . | Audio Quality, | | |
| | | | Conference | | Video Quality, | | |
| | | | Call, . . . | | Voice Codec, | | |
| | | | | | Video Codec, . . . | | |
| | Mobile | Supported | Broadcast, | Video, | CPU Performance, | Other | Unavailable |
| | Phone | | Messenger, | Audio, | Memory | | |
| | | | Voice Call, . . . | Image, | Performance, | | |
| | | | | Text, . . . | Audio Quality, | | |
| | | | | | Video Quality, | | |
| | | | | | Voice Codec, | | |
| | | | | | Video Codec, . . . | | |
| | IP STB | Supported | Broadcast, | Video, | CPU Performance, | Home | Available |
| | | | Messenger, | Audio, | Memory | | |
| | | | Voice Call, | Image, | Performance, | | |
| | | | Video Call, . . . | Text, . . . | Audio Quality, | | |
| | | | | | Video Quality, | | |
| | | | | | Voice Codec, | | |
| | | | | | Video Codec, . . . | | |
| Jane | Mobile | Not | Messenger, | Audio, | CPU Performance, | Other | Available |
| | Phone | Supported | Voice Call . . . | Image, | Memory | | |
| | | | | Text, . . . | Performance, | | |
| | | | | | Audio Quality, | | |
| | | | | | Video Quality, | | |
| | | | | | Voice Codec, | | |
| | | | | | Video Codec, . . . | | |
| | IP STB | Supported | Broadcast, | Video, | CPU Performance, | Home | Unavailable |
| | | | Messenger, | Audio, | Memory | | |
| | | | Voice Call, | Image, | Performance, | | |
| | | | Video Call, ... | Text, . . . | Audio Quality, | | |
| | | | | | Video Quality, | | |
| | | | | | Voice Codec, | | |
| | | | | | Video Codec, . . . | | |
| | . . . | . . . | . . . | . . . | . . . | . . . | . . . |

Referring to Table 1, the user terminal information DB 230 stores information on the kinds terminals possessed by each user, whether media transfer is supported by each terminal, available services for each terminal, available media for each terminal, terminal attributes, current location information, and current state information that indicates whether a terminal can be used. In particular, the current location information and current state information of each terminal can frequently change according to information collected by the user terminal information managing unit 220.

The service information managing unit 250 monitors the state of a service being currently used by a user, stores and manages the result of monitoring in the service information DB 260.

The service information DB 260 stores, in a tabular format, media including services subscribed to and used, service attribute information, and recommended terminal performance information needed for receiving a corresponding service, for each user. One example of which is Table 2 below.

TABLE 2

| | | Component | | Recommended |
|---|---|---|---|---|
| User | Service | Media | Service Attributes | Performance |
| John | Broadcast | Audio, | Audio Quality, Video Quality, | CPU Performance, |
| | | Video, Text, | Voice Codec, Video Codec, | Memory |
| | | Image | Image Quality, . . . | Performance, . . . |
| | Voice Call | Audio | Audio Quality, Voice Codec, | CPU Performance, |
| | | | . . . | Memory |
| | | | | Performance, . . . |
| | Video Call | Audio, Video | Audio Quality, Video Quality, | CPU Performance, |
| | | | Voice Codec, Video Codec, . . . | Memory |
| | | | | Performance, . . . |
| | Conference | Audio, | Audio Quality, Video Quality, | CPU Performance, |
| | Call | Video, Text | Voice Codec, Video Codec, . . . | Memory |
| | | | | Performance, . . . |
| | Messenger | Text, Image | Image Quality, . . . | CPU Performance, |
| | | | | Memory |
| | | | | Performance, . . . |
| . . . | . . . | . . . | . . . | . . . |

The media transfer terminal determining unit 270 determines one or more transfer terminals to which each of one or more media composing a multimedia service is transferred, as a user's location changes. In other words, in response to output of a signal from the user location monitoring unit 210 informing that the location of a user has changed, the media transfer terminal determining unit 270 obtains information on a current service in use and user available terminals at a location to be changed to from the user terminal information managing unit 220 and the service information managing unit 250. According to the information obtained, the media transfer terminal determining unit then determines one or more transfer terminals to which each of one or media composing a multimedia service is transferred.

The media preference managing unit 280 obtains information on preferred media and use location when using a service through user terminals, and stores the information in the media preference information DB 290.

The media preference information DB 290 stores, in tabular format, the obtained information on preferred media and use location when using a service through user terminals. One example is Table 3 below.

TABLE 3

| | User | | Preferred | Preferred | Preferred | Preferred | Preferred |
|---|---|---|---|---|---|---|---|
| User | Confirmation | Terminal | Media1 | Media2 | Media3 | Media4 | Location |
| John | Required | PC1 | Audio | Text | Image | . . . | Work |
| | | PC2 | Video | Audio | Image | . . . | Home |
| | | Mobile | Audio | Text | Video | . . . | Work |
| | | Phone1 | | | | | |
| | | Mobile | Video | Audio | Text | . . . | Other |
| | | Phone2 | | | | | |
| | | IP STB1 | Video | Audio | Image | . . . | Home |
| | | IP STB2 | Video | Audio | Text | . . . | Home |
| | | Notebook | Text | Video | Audio | . . . | Work |
| | | Computer | | | | | |
| | | MID | Audio | Text | Image | . . . | Other |
| Jane | Not | PC | Video | Audio | Image | . . . | Home |
| | Required | Mobile | Audio | Text | Video | . . . | Other |
| | | Phone | | | | | |
| | | IP STB | Video | Audio | Text | . . . | Home |
| | | . . . | . . . | . . . | . . . | . . . | . . . |

Referring to Table 3, the media preference information DB 290 stores, for each user, information such as the kind of each terminal, whether to require user confirmation if there is a need for media transfer between terminals, user media preference, and preferred place for using a service. The media preference managing unit 280 asks a user in real time and obtains preference information if the item “user confirmation” in Table 3 is marked as “required”.

While Table 3 lists information on preferred media and preferred location for each terminal, with respect to terminals possessed by a user, it can alternatively configure information on preferred terminals and preferred location based on media being used by a user. In other words, the kinds of terminals which users can possess, the number of terminals, the kinds of preferred media, and the kinds of preferred places are not limited to those presented in Table 3.

Thus, the media transfer terminal determining unit 270 determines a media transfer terminal with reference to information obtained by the media preference managing unit 280 as well as information obtained by the user terminal information managing unit 220 and the service information managing unit 250.

The media transfer terminal information providing unit 295 sends media transfer-capable terminal information selected by the media transfer terminal determining unit 270 to the media transfer control server 120 or a user terminal 130.

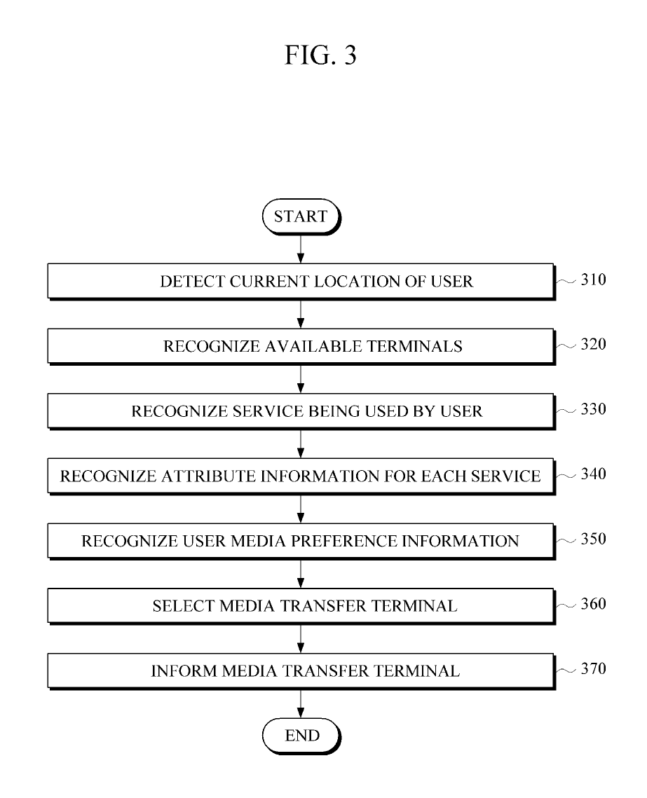

FIG. 3 is a flowchart illustrating an example of a method of determining a media transfer terminal according to an example embodiment of the present invention.

Referring to FIG. 3, in operation 310, the media transfer terminal determining server 110 recognizes a change in the user location and obtains information on where a user is currently.

Then, in operation 320, the media transfer terminal determining server 110 selects available user terminals that are located at the changed user location. In other words, with reference to Table 1 above, terminals that support media transfer and are available are selected.

In operation 330, the media transfer terminal determining server 110 recognizes a service being currently used by a user. Then, in operation 340, if the current service used by the user is recognized, attribute information related to the current service of the user is recognized. In other words, with reference to Table 2 above, the attribute information of available terminals at the changed location of the user is recognized.

Then, in operation 350, the media transfer terminal determining server 110 recognizes terminals preferred by the user depending on media, based on information of the user's current location and user's current service obtained. In other words, with reference to Table 3 above, the media transfer terminal determining server 110 determines certain user preferred terminals that can be used at the changed user location and that are suitable for the attributes of the service being currently used by the user. While the media transfer terminal determining server 110 can determine the information on preferred terminals with reference to pre-stored Table 3, it can also make the determination by asking the user in real time.

In operation 360, the media transfer terminal determining server 110 analyzes information on available terminals, attributes for each service, and user media preference obtained previously, and determines suitable transfer terminals for each of one or more media composing multimedia.

In operation 370, the media transfer terminal determining server 110 sends the determined media transfer terminal information to the transfer terminal control server 120 and a corresponding user terminal 130. The present invention has an advantage in that various needs of a user can be satisfied since individual media of a service can be separately transferred between terminals, as the location of the user using a multimedia service changes.

While the invention has been described above with reference to various embodiments, it will be understood that changes and modifications may be made without departing from the scope of the invention, which is defined by the appended claims and their equivalents.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as in Internet transmission. In addition, the computer-readable recording medium may be distributed among computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of selecting one or more media transfer terminals to which to transfer each of one or more media composing multimedia, by a media transfer terminal determining server, the method comprising:
recognizing a change in a location of a user;
recognizing available terminals at the changed location of the user;
recognizing attribute information of a multimedia service being currently used by the user; and
selecting one or more of the available terminals through which one or more media are provided according to the attribute information.

2. The method of claim 1, further comprising:
recognizing user-preferred terminal information for each medium,
wherein the selecting is based on the user-preferred terminal information for each medium.

3. The method of claim 2, wherein the recognizing of user-preferred terminal information for each medium is done by asking the user about preferred terminal information in real time.

4. The method of claim 1, further comprising:
sending transfer-capable terminal information determined for each medium to a media transfer control server, which conducts media transfer.

5. An apparatus for selecting media transfer terminals, the apparatus comprising:
a user location monitoring unit configured to monitor a current location of a user and detect a change in the location of the user;
a user terminal information managing unit configured to detect available terminals at the user location detected by the user location monitoring unit;
a service information managing unit configured to detect attribute information of a multimedia service being currently used by the user; and
a media transfer terminal determining unit configured to select one or more of the available terminals detected by the user terminal information managing unit to receive transfer of each of one or more media composing a multimedia service, such that the selected one or more available terminals are suitable for the attribute information of the multimedia service currently in use detected by the service information managing unit.

6. The apparatus of claim 5, further comprising:
a user terminal information DB that stores information about terminals possessed by each user in a tabular format,
wherein the user terminal information managing unit manages information stored in the user terminal information DB and detects available terminals from the user terminal information DB.

7. The apparatus of claim 6, wherein the user terminal information DB stores information on at least one of kinds terminals possessed by each user, whether media transfer is supported by each terminal, available services for each terminal, available media for each terminal, terminal attributes, and current state information of each terminal.

8. The apparatus of claim 5, further comprising:
a service information DB that stores service attribute information of services subscribed to by each user in a tabular format,
wherein the service information managing unit manages the information stored in the service information DB and detects the multimedia service information from the service information DB.

9. The apparatus of claim 8, wherein the service information DB includes information on at least one of kinds of services subscribed to by each user, media for each service, service attributes, and recommended terminal performance according to service.

10. The apparatus of claim 5, further comprising:
a media preference managing unit that manages preferred media and use location information when using services through terminals possessed by a user.

11. The apparatus of claim 10, further comprising:
a media preference information DB that stores the preferred media and use location information when using services through terminals possessed by a user,
wherein the media preference managing unit detects and outputs terminal information preferred by the user to use a service being currently used by the user at a location of the user, to the media transfer terminal determining unit.

12. The apparatus of claim 11, wherein in the media preference information DB, there are at least two preferred media for each of one or more terminals possessed by each user.

13. The apparatus of claim 11, wherein the media preference information DB further stores information on whether confirmation of a user is required if media transfer between terminals is required, and the media preference managing unit asks the user about user preference in real time if it is determined that user confirmation is required.
